(19) United States
(12) Patent Application Publication
(10) Pub. No.: US 2007/0146510 A1
(43) Pub. Date: Jun. 28, 2007

(54) IMAGE PROCESSING MODULE, DATA PROCESSING MODULE AND METHODS FOR USING THE SAME

(75) Inventors: Ching-Hsiu Lin, Taipei (TW); Chia-Hsin Chen, Taipei (TW); Lien-Wei Lee, Taipei (TW)

Correspondence Address: Daniel R. McClure;Thomas, Kayden, Horstemeyer & Risley LLP, Suite 1750, 100 Galleria Parkway, Atlanta, GA, 30339, US

(73) Assignee: Beyond Innovation Technology Co., Ltd., Taipei (TW)

(21) Appl. No.: 11/379,398

(22) Filed: Apr. 20, 2006

(30) Foreign Application Priority Data
Dec. 22, 2005 (TW) 94145799

(51) Int. Cl. H04N 5/202

(52) U.S. Cl. 348/254

(57) ABSTRACT

An image processing module substantially matches the representation of a display with the expectation of image data. The image processing module comprises a storage unit, a control unit, and an image processing unit. The storage unit stores calibration information with calibration values each corresponding to a physical area on the display. The control unit receives timing data and mode data to accordingly direct the storage unit to output corresponding calibration value. An image processing unit is controlled by the control unit to calibrate the image data according to the corresponding calibration value and output calibrated image data.

### BACKGROUND OF THE INVENTION

1. Field of the Invention

The invention relates to a data processing method and a data processing apparatus, and in particular to an image data processing method and an image data processing apparatus.

2. Description of the Related Art

Different pixels (or lines) of a display apparatus may have produce different color performance for the same data for reasons such as manufacturing or processing deviation on the different pixels. For example, the geographical dependence shown in FIG. 1(a) is generally obtained even though the ideal result of FIG. 1(b) is preferred.

FIG. 3 shows a conventional control scheme for a display apparatus, having an analog-to-digital converter (ADC) 100, an image scaling module 200, an image processing module 300 and a display module 400. ADC 100 converts image data from analog form to digital form. Based upon received digital control data, image scaling module 200 processes the digitalized image data, scaling the image data. After scaling, image processing module 300 performs image correction or calibration comprising, for example, brightness, contract, sharpness, or gamma values. Finally, display module 400 displays images according to the image data from image processing module 300.

Conventional image processing modules substantially process data by frame, such that conventional calibration only shifts the line of geographical dependence in parallel, without straightening it, as shown in FIG. 1(c). Therefore, the conventional image processing modules cannot calibrate specific locations inside a frame if calibration of the specific locations is desired. Further, TFT LCD displays, due to characteristics of liquid crystal, must be periodically inverted. FIG. 2(c) shows a preferred relationship between input and output signals, wherein one line refers to a non-inversion mode and the other refers to an inversion mode. The lines in FIG. 2(cl ) are straight and angled about 45° from a horizontal line, such that the input and output data have the same value in the non-inversion mode and said data are complimentary in inversion mode. These two straight lines also represent the linear relationship between the input and output data irrespective of mode. Due to device deviation and mismatch, output data may differ from input data, with the line for inversion mode deviating from a mirror image of the line for non-inversion mode, as shown in FIG. 2(a). Conventional technology employs one signal formula to calibrate the output data in both non-inversion and inversion modes. One of the possible results of the conventional technology is shown in FIG. 2(b), where, even the line for non-inversion mode is calibrated to become straight, the line for the inversion mode is still a curve, representing an unwanted, non-linear relationship between the input and output signals. Thus, the conventional technology cannot create two straight lines as ideally expected in FIG. 2(c), such that conventional image processing modules fail to provide good images quality.

### BRIEF SUMMARY OF THE INVENTION

One embodiment of the present invention provides an image processing module comprising a storage unit, a control unit, and an image processing unit. The storage unit stores calibration information with calibration values each corresponding to a physical area on a display. The control unit receives timing data and mode data to accordingly direct the storage unit to output a corresponding calibration value. The image processing unit is controlled by the control unit to calibrate image data according to the corresponding calibration value and output calibrated image data.

One embodiment of the present invention provides a data processing module controlling an apparatus that has operation units. The data processing module comprising a storage unit, a control unit, and a processing unit. The storage unit stores calibration information with calibration values, each respectively corresponding to one operation unit. A control unit receives timing data and mode data to accordingly direct the storage unit to output a corresponding calibration value. The processing unit is controlled by the control unit to calibrate control data according to the corresponding calibration value and output calibrated control data, such that the representation of the apparatus under the control of the data processing module substantially matches the expectation of the control data.

One embodiment of the present invention provides an image data processing method. Timing data and mode data are first received. A corresponding calibration value is output from a storage unit according to the timing data and the mode data. Image data is calibrated according to the corresponding calibration value to output calibrated image data. The corresponding calibration value corresponds to a spatial location to which the timing data refers.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1(a) shows line-dependence of the performance of a liquid crystal display;

FIG. 1(b) shows expected line-independence of performance of a liquid crystal display;

FIG. 1(c) shows a conventional calibration method shifting only the curve of a line-dependence;

FIG. 1(d) shows line-independence performed according to an image processing module of the invention;

FIG. 2(a) shows a possible relationship between input data and output data of a liquid crystal under inversion or non-inversion;

FIG. 2(b) shows a calibrated relationship between input data and output data after processing by conventional calibration;

FIG. 2(c) shows a preferred relationship between input data and output data of a liquid crystal under inversion or non-inversion;

FIG. 2(d) shows the relationships between input data and output data processed by a calibration method of the invention;

FIG. 3 shows a conventional control scheme for a display apparatus;

FIG. 4 shows operation of an image processing module according to an embodiment of the invention;

FIG. 5 exemplifies the calibration information stored in a storage unit; and

FIG. 6 lists the possible and selectable calibration modes according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

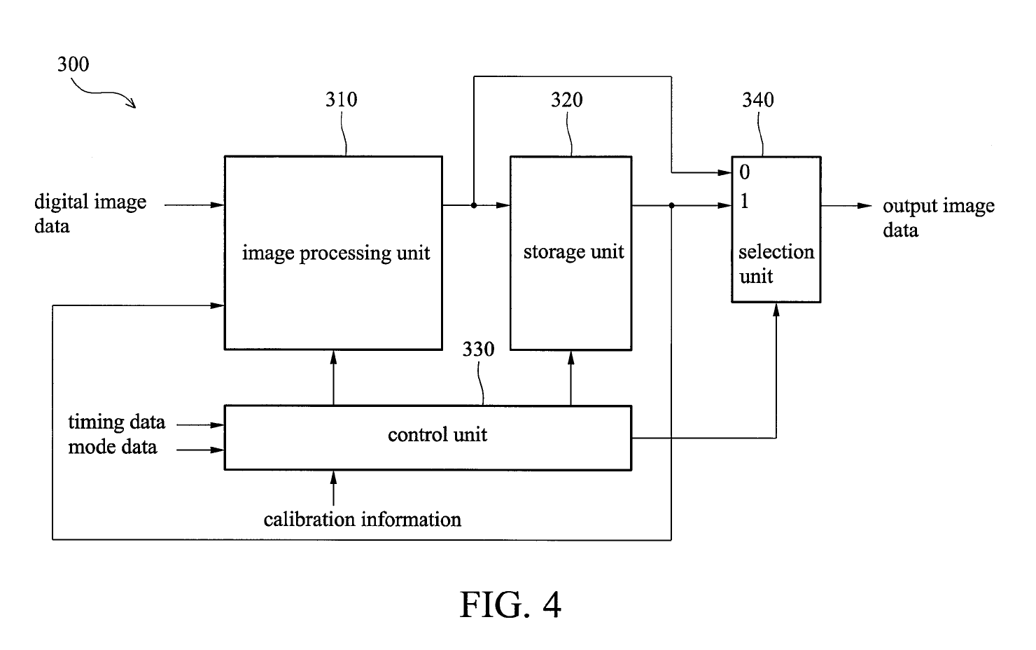

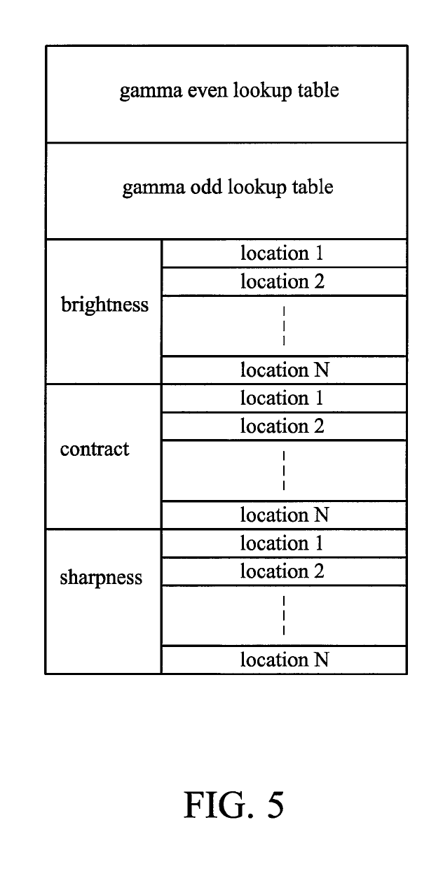

FIG. 4 shows operation of an image processing module according to one embodiment of the invention. The image processing module 300 comprises an image processing unit 310, a storage unit 320, a control unit 330, and a selection unit 340. Image processing unit 310 calibrates received digital image data. Storage unit 320 stores calibration information, to corresponding addresses, including correction or calibration values, as shown in FIG. 5, the values of which may relate to calibration of gamma, brightness, contrast, sharpness, etc. Some of the values stored in storage unit 320 correspond to a physical area on a display. For example, each value of brightness calibration in storage unit 320 corresponds to a dot, a pixel, a row, a column, or a predetermined section of a display. Control unit 330 controls the image process executed by image processing unit 310, and allocates memory addresses in storage unit 320 such that corresponding values in storage unit 320 can be properly output for calibration or correction.

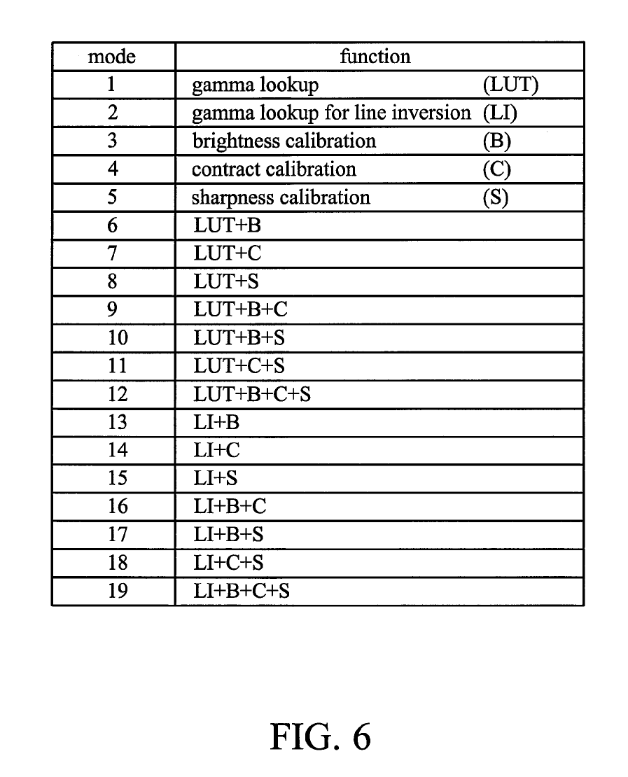

The following details the operation of image processing module 300. Control unit 330 receives timing data (for example, vertical synchronization, horizontal synchronization, or pixel clock), mode data (shown in FIG. 6 as an example), and calibration information (for example, calibrations of gamma, brightness, contrast, or sharpness). Control unit 330 then stores the calibration information to corresponding addresses in storage unit 320, and values for one type of calibration are gathered together. Thereafter, control unit 330 chooses a calibration or correction function(s), corresponding to the mode data. If the mode data indicates mode 14 in FIG. 6, for example, line inversion gamma calibration and contrast calibration are required. Control unit 330 then controls the values corresponding to the required function(s) and the timing of the timing data to output to image processing unit 310. Image processing unit 310 accordingly executes image processing based upon the received digital image data and the values from storage unit 320, such that calibrated image data is sent to storage unit 320 and selection unit 340. If image processing unit 310 performs only calibrations other than desired gamma calibration, storage unit 320 can provide gamma calibration. Storage unit 320 checks a gamma lookup table stored therein with calibrated image data to accordingly output gamma-calibrated data to selection unit 340. Based upon the command of control unit 330, selection unit 340 chooses the gamma-calibrated data from storage unit 320 or the calibrated image data from image processing unit 310 for outputting. Selection unit 340 may be a multiplexer.

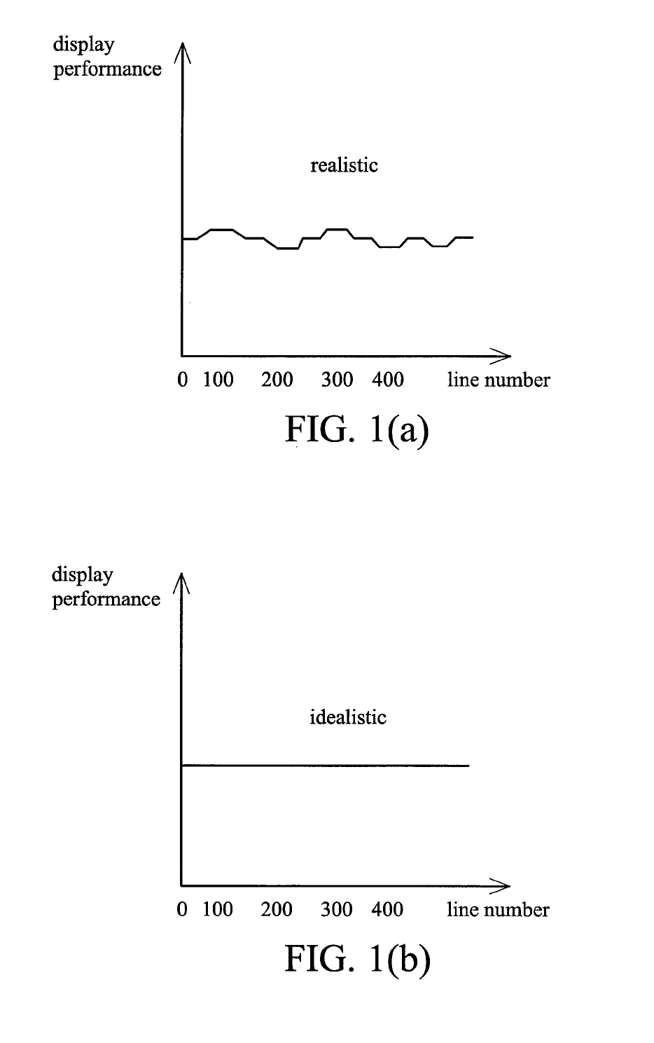

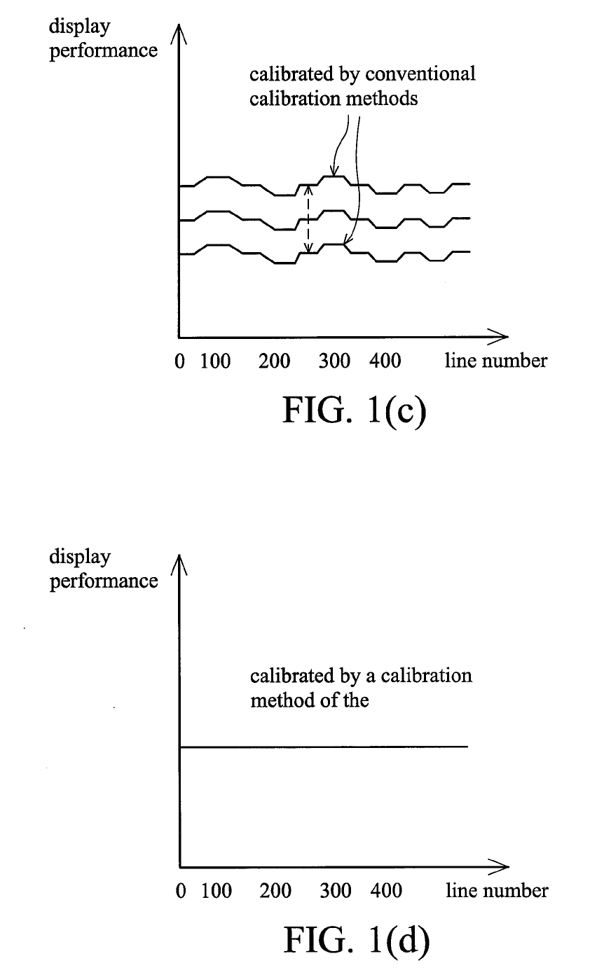

In embodiments of the invention, calibration information must be first set. If dot calibration of a liquid crystal display is required, calibration information regarding to each dot on the liquid crystal display must be determined. If a specific dot of the liquid crystal display performs as if having a brightness value of 100 while receiving a signal with a brightness value of 80, the brightness calibration value for that specific dot is 0.8(=80/100) when multiplication operation is employed, minus 20(=80−100) when addition operation is employed, or another corresponding value when another kind of operation is employed. The brightness calibration value is stored in a section of storage unit 320 for brightness calibration to an address corresponding to the specific dot of the liquid crystal display. Accordingly, calibration information regarding to sharpness, brightness, contract or other features of each dot can also be stored to corresponding addresses. In other words, the calibration values in the calibration information have a spatial correspondence with the liquid crystal display. The timing data assures that the image data of which dots is going to be calibrated by image processing unit 310, such that storage unit 320 outputs the calibration information in a corresponding address and sends it to image processing unit 310. According to the received calibration information, image processing unit 310 calibrates the image data of the dot. For example, if the received calibration information is minus 20 and the current value of the original image data is 80, then image processing unit 310 outputs a calibrated image data with a value of 60 to make the real performance of a corresponding dot on a liquid crystal display 80. Since the image data of each dot can be calibrated by corresponding calibration information in a corresponding address of storage unit 320, it is expected that the performance of the liquid crystal display can be idealized as shown in FIG. 1(d).

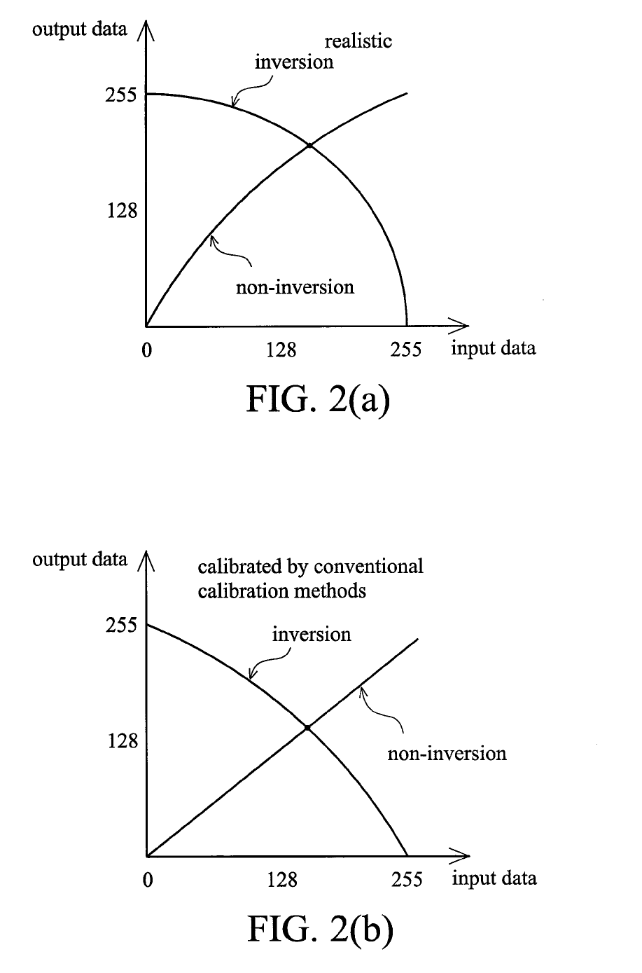

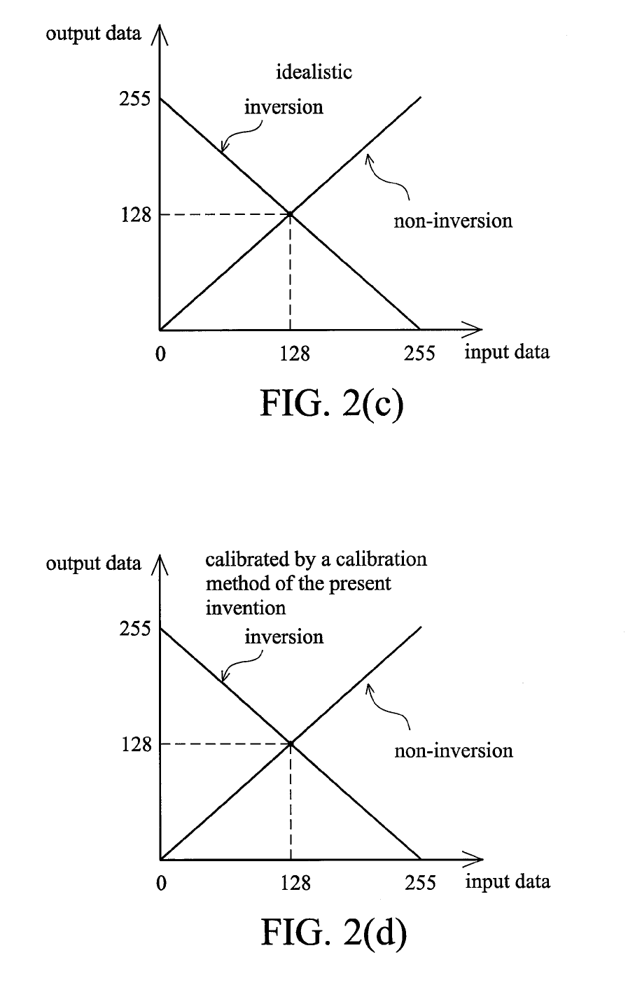

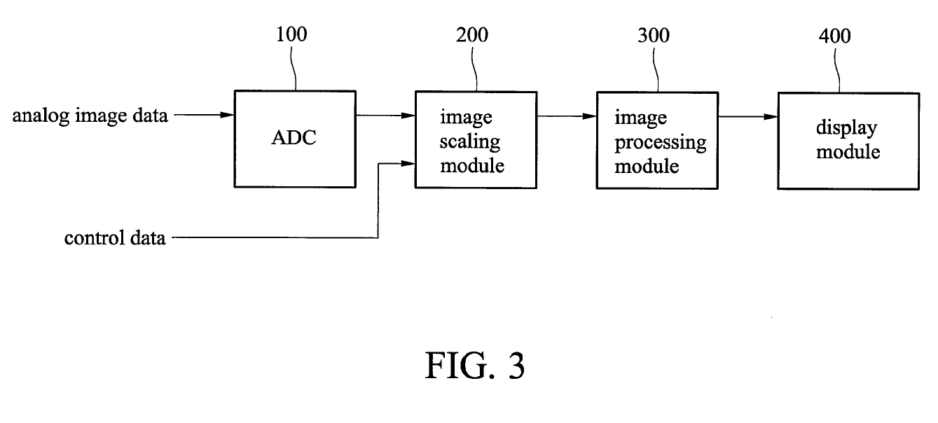

As described, the liquid crystal in TFT LCD apparatuses must be periodically inverted. The inversion schemes commonly used in the art include dot, pixel, and line inversion. Here, the line inversion is used as an example. Operation scheme of a line inversion are odd lines of a display at one status while even lines at the other with these two statuses exchanged periodically. For example, in one frame period, odd lines are in non-inversion status when even lines are in inversion status, and in the following frame period, odd lines are in inversion status when even lines are in non-inversion status. Liquid crystal performs differently when operated under a different status. Thus, a gamma lookup table preferably has two lookup tables: hereinafter, one named a gamma even table for inverted lines and the other named a gamma odd table for non-inverted lines. Thus, at one frame for a first line period, storage unit 320 (under the control of control unit 330) provides the values in the gamma even table for the first line, for the second line period, provides the values in the gamma odd table for the second line, for the third line period, provides the values in the gamma even table for the third line and so on. At next frame, each line is provided with other gamma even table, i.e., the gamma odd table the first line, the gamma even table the second line, and so on. Thus, the result in FIG. 2(d) can be achieved. For the line-to-line difference for gamma calibration, only a gamma even table for all inverted lines and a gamma odd table for all non-inverted lines might not be enough. Thus, a gamma lookup table can also comprise pairs of tables, each pair corresponding to one line on a display and comprising a gamma even table and a gamma odd table. Furthermore, suitable values for brightness, sharpness, or contract calibration under non-inversion can differ slightly from those under inversion. Therefore, the values of the calibration information regarding to brightness, sharpness, or contract can correspond not only to a physical area on a display, but also to an inversion type. For example, the calibration of brightness for a line might have two values: one for inversion and the other for non-inversion.

One object of the invention is to calibrate or correct image data to provide a displayed image substantially the same as expected. The image process employed in the invention can thus be utilized at any stage in the image process flow from the original image data to a display. In other words, the digital image data input to image processing unit 310 may be calibrated image data or not being calibrated image data, and the output image data from image processing unit 310 may directly output to a display or output to other image processing for further processing. Furthermore, the gamma calibration provided by storage unit 320 in the embodiments can be omitted and relocated to a previous process stage or a following stage.

In addition to image processing of individual lines or dots, the invention can further provide image processing to a pixel, a row, a column, or a predetermined section on the display.

In practice, storage unit 320 can utilize a conventional storage unit storing 3 gamma lookup tables for 3 colors (RGB). The storage capacity for 2 gamma lookup tables can be replaced and stores the calibration values relating to calibration of brightness, contrast, or sharpness while the gamma calibration of 3 colors (RGB) shares the remaining gamma lookup table, which occupies one third of the total capacity of the storage unit. Hence, the invention can be embodied without complicated hardware modification.

The invention is applicable, but not limited, to applications in image process. One object of the invention is to modify, calibrate, or correct an input data, such that output data can generate an expected performance. More especially, the modification, calibration or correction is based upon the geographical deviation of a physical application that uses the data, such that the performance for the physical application has no geographical dependence. For example, the invention can be embodied by a data processing module for controlling an apparatus. In the data processing module, a storage unit store mode calibration information, which is utilized to calibrate a control data in order to make the representation of the apparatus under the control of the data processing module substantially match the expectation of the control data. If the apparatus has several operation units, the mode calibration information can have portions respectively corresponding to the operation units for better calibration or correction.

While the invention has been described by way of examples and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing module, comprising:
a storage unit storing calibration information, the calibration information including calibration values each corresponding to a physical area on a display;
a control unit receiving timing data and mode data to accordingly direct the storage unit to output a corresponding calibration value; and
an image processing unit controlled by the control unit to calibrate image data according to the corresponding calibration value and output calibrated image data.

2. The image processing module as claimed in claim 1, wherein the control unit further receives the calibration information, and stores the calibration information to corresponding addresses in the storage unit.

3. The image processing module as claimed in claim 1, wherein the calibration information comprises a gamma lookup table.

4. The image processing module as claimed in claim 3, wherein the storage unit outputs gamma-calibrated image data according to the calibrated image data.

5. The image processing module as claimed in claim 4, further comprising a selection unit receiving the calibrated image data and the gamma-calibrated image data and selectively outputting one of the calibrated image data and the gamma-calibrated image data.

6. The image processing module as claimed in claim 5, wherein the control unit controls the selection of the selection unit based on the mode data.

7. The image processing module as claimed in claim 3, wherein the gamma lookup table occupies one third the space of the storage unit.

8. The image processing module as claimed in claim 1, wherein the physical area on the display is that of a dot, pixel, row, column, or predetermined section on the display.

9. The image processing module as claimed in claim 1, wherein the mode data comprises values of contrast, brightness, sharpness, gamma, or a combination thereof.

10. The image processing module as claimed in claim 9, wherein the display is a liquid crystal display, and the calibration values comprise inversion and non-inversion mode of the liquid crystal for the liquid crystal display.

11. The image processing module as claimed in claim 1, wherein the display is a liquid crystal display, and the calibration values comprise inversion and non-inversion mode values of the liquid crystal for the liquid crystal display

12. The image processing module as claimed in claim 9, wherein the calibration information comprises a gamma lookup table including a gamma odd table and a gamma even table used for gamma calibration during non-inversion and inversion of the liquid crystal, respectively.

13. A data processing module for controlling an apparatus that has operation units, comprising:
a storage unit storing calibration information with calibration values, each respectively corresponding to one of the operation units;
a control unit receiving timing data and mode data to accordingly direct the storage unit to output a corresponding calibration value; and
a processing unit controlled by the control unit to calibrate control data according to the corresponding calibration value and output calibrated control data, such that the representation of the apparatus under the control of the data processing module substantially matches the expectation of the control data.

14. The data processing module as claimed in claim 13, wherein the apparatus is a display.

15. The data processing module as claimed in claim 14, wherein the calibration information comprises at least one mode values of contrast, brightness, sharpness, gamma, or a combination thereof.

16. The data processing module as claimed in claim 14, wherein the display is a liquid crystal display, and the calibration values further comprise inversion and non-inversion mode values of the liquid crystal.

17. The data processing module as claimed in claim 16, wherein the calibration values have a spatial correspondence with the liquid crystal display.

18. The data processing module as claimed in claim 17, wherein the spatial correspondence is related to a dot, pixel, row, column, or predetermined section on the liquid crystal display.

19. An image data processing method, comprising:
receiving timing data and mode data;
according to the timing data and the mode data, directing a storage unit to output a corresponding calibration value; and
calibrating image data according to the corresponding calibration value and outputting a calibrated image data,
wherein the corresponding calibration value corresponds to a spatial location to which the timing data refers.

20. The image data processing method as claimed in claim 19, wherein the storage unit stores calibration information, and the calibration information has calibration values each corresponding to a physical area on a display.

21. The image data processing method as claimed in claim 20, further comprising receiving the calibration information to store the calibration information in corresponding addresses in the storage unit.

22. The image data processing method as claimed in claim 20, further comprising:
outputting a gamma-calibrated image data according to the calibrated image data; and
outputting one of the gamma-calibrated image data and the calibrated image data.

23. The image data processing method as claimed in claim 20, wherein the corresponding calibration value has a spatial correspondence with a dot, a pixel, a row, a column, or a predetermined section.
